(19) United States
(12) Patent Application Publication
(10) Pub. No.: US 2006/0013738 A1
(43) Pub. Date: Jan. 19, 2006

(54) Oral fluid collector with integrated drug screening system

(76) Inventor: James T. Ramsey, Virginia Beach, VA (US)

Correspondence Address: SETO PATENTS, 406 RIVERLAND DR., SALEM, VA, 24153, US

(21) Appl. No.: 11/181,457

(22) Filed: Jul. 15, 2005

Related U.S. Application Data
(60) Provisional application No. 60/588,430, filed on Jul. 16, 2004.

(51) Int. Cl. B01L 3/00

(52) U.S. Cl. 422/99

(57) ABSTRACT

An integrated collection and testing device designed to collect oral fluid and immediately begin a testing process, such as for drugs of abuse. The test strips are held within a housing that also doubles as a handle. A collection swab at one end of the handle is made of absorbent material that has the ability to saturate itself when placed in the mouth. A special strip of absorbent material connects the collection swab to the test strips and assists the flow of the oral fluid to the test strips. After collection of the oral fluid, a security cap is placed over the collection swab and locked in place. At the same time, a small amount of oral fluid is collected in a confirmation reservoir that is within the security cap.

### BACKGROUND OF THE INVENTION

The present invention was originally disclosed in U.S. provisional patent application Ser. No. 60/588,430 filed on Jul. 16, 2004, and priority is claimed to the provisional patent application.

The present invention relates generally to the field of drug screening and more specifically to drug screens that test oral fluid.

Drug screening tests are well known in the personnel offices around the world. Employers commonly require tests for drugs of abuse, such as cocaine and heroin, and these tests have become an ordinary part of a job application. In the sports world, it is also common to test athletes for performance enhancing drugs such as certain steroids. Many drug screen tests include dipsticks that have been treated with chemicals so that they react to by-products of specific drugs. When the treated sites are exposed to a sample fluid from a job applicant or athlete, the dipsticks can provide almost immediate onsite testing. Other drug screens use test cards, which are cards that have had multiple sites on the card chemically treated so that multiple drugs can be tested for simultaneously. Test cards are used in the same manner as dipsticks, i.e., testing is conducted by exposing the card to a fluid sample, waiting a specified period of time and then reading the indication sites on the card.

In a traditional drug screen test, a sample provider deposits a urine sample into a collection cup, places a lid on the cup and then places a piece of tape over the lid so that the tape extends down over the lid and onto the cup. This piece of tape is intended to insure that no other substance is added to the urine sample prior to testing. The sample provider then hands the sealed collection cup to a test administrator. In order to gain access to the urine sample, the test administrator must break the seal that secures the lid to the top of the collection cup. At this point it is possible for other substances to fall, accidentally or otherwise, into the collection cup and taint the sample. The addition of foreign substances to a collected sample usually causes invalid test results and requires re-testing.

What is needed in the field is a self-contained collection and testing device that does not require exposure of the sample in order to test the sample. The ideal testing device would also test on a saliva sample, or oral fluid, so that a private bathroom is not required for collection of the sample.

### SUMMARY OF THE INVENTION

A device that is adapted for partial insertion into a test subject's mouth, wherein the device efficiently collects oral fluid from the test subject and automatically begins a testing process on the collected oral fluid. The collection and testing device comprises a handle, a collection swab, a strip of flow assisting material and a shield. The handle substantially defines the length of the device, and has a closed end and an open end. At least one test strip is housed within the interior of the handle. The collection swab is attached to the open end of the handle and held in place by a swab support. The flow assisting material connects the collection swab to the at least one test strip and aids in the flow of the collected oral fluid to the at least one test strip. The shield is attached to the open end of the handle and at least partially extends over the collection swab. The shield is designed to prevent damage and tampering to the flow assisting material and the at least one test strip.

A security cap is provided for covering the collection swab after the collection process. When the cap is in place over the collection swab, it locks onto the handle and cannot be removed without breaking the locking mechanism. The cap includes an espressor plate that at least partially compresses the collection swab when the cap is placed in the locked position. The cap also includes a confirmation reservoir that receives a small amount of the oral fluid from the at least partially compressed collection swab when the cap is placed in the locked position. The confirmation reservoir includes a confirmation seal, such as a confirmation plug, that must be broken in order to remove the small amount of oral fluid from the confirmation reservoir.

The at least one test strip can be used to indicate use of drugs of abuse, including cocaine, heroin and amphetamines, by the test subject. The test strip(s) can also be used to indicate other conditions, such as pregnancy. The handle is preferably made of a clear material so that the at least one test strip is visible through the handle.

It is an object of the present invention to provide a device that both collects and tests an oral fluid sample from a test subject.

It is another object of the invention to house the test strips in the handle of the device so that a slim and easy to use testing device is created.

It is a further object of the present invention to prevent tampering with the test strips and provide a confirmation sample from the collected oral fluid.

### BRIEF DESCRIPTION OF THE DRAWINGS

The invention of the present application will be described in detail with reference to the accompanying drawings, given only by way of example, in which:

FIG. 1 (a) shows a side view of the preferred embodiment;

FIG. 1 (b) shows a side view of the cap for the preferred embodiment;

FIG. 2 shows a top view of the preferred embodiment; and,

FIG. 3 shows a top view of an alternative embodiment.

### DETAILED DESCRIPTION OF THE INVENTION

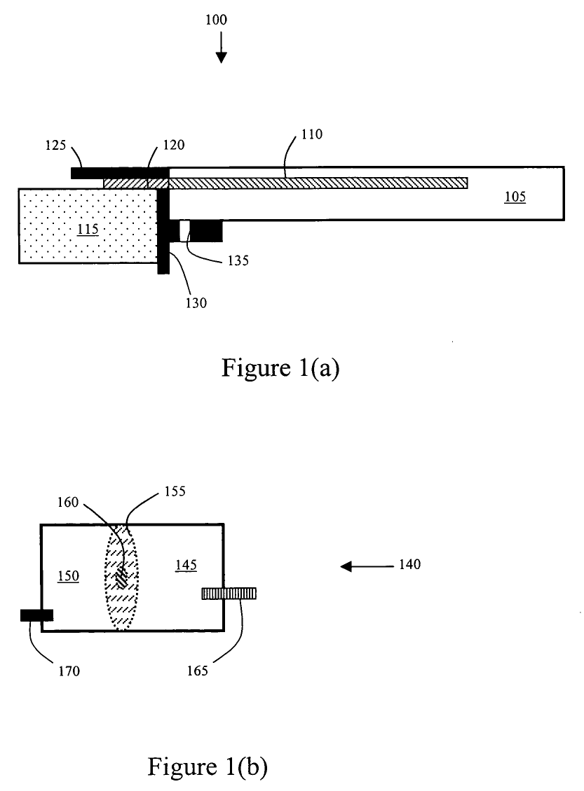

FIG. 1(a) shows a side view of the preferred embodiment 100 of the present oral fluid collector with integrated drug screening system. The device comprises a collection swab 115 made of absorbent material that when placed in the mouth will saturate itself with oral fluid, or saliva, from the test subject's mouth. Test strip 110, which is capable of indicating the presence of one or more particular substances or metabolites that may be present in the saliva, is in fluid connection with the collection swab 115. Each particular substance or metabolite that is tested for is associated with either use of a particular drug or existence of a particular condition, such as being pregnant. Such test strips are well known in the art and commercially available. The collection swab 115 is in fluid connection with the test strip 110 via a flow guide 120, which assists in the flow of the oral fluid from the swab 115 to the test strip 110. After the swab 115 is saturated, the collected oral fluid is drawn to the test strip 110 via the flow guide 120 and the testing process automatically begins. A protective shield 125 covers the flow guide 120 and the exposed portion of the test strip 110. The shield 125 protects and prevents tampering with the flow guide 120 and the test strip 110. The housing 105 of the present device provides a protective clear covering for the test strip 110 and also prevents damage and tampering with the test strip 110. The housing 105 also doubles as a handle, which allows for a slim design and assists the test subject in holding the device during the collection process. The swab support 130 is a piece of plastic that attaches the swab to the housing 105. Lock clasp 135 is attached to the housing 105 and is the female portion of a locking mechanism that is adapted to permanently hold a male portion, which is located in the cap.

FIG. 1(b) shows the cap 140 for the preferred embodiment 100 of the present collection and testing device. After approximately three minutes of collection time, the cap 140 is placed over the swab 115 and the shield 125. The cap 140 includes the male portion 165 of a locking mechanism that locks the cap 140 to the female portion 135 on the housing 105. In the preferred embodiment, the locking mechanism cannot be released once the cap 140 is in the locked position. And, the only way to remove the cap is by breaking the locking mechanism. This allows the locking mechanism to be a simple slip-lock mechanism, which is used in slip-lock handcuffs, also called plastic strap handcuff. An espressor plate 155 within the cap 140 compresses the swab 115 when the cap is placed in the locked position. This compression causes a small amount of the oral fluid in the swab 115 to be forced into a confirmation reservoir 150 located in the far end of the cap 140. The espressor plate 155 includes one or more one way flow valves 160 that trap the small sample of oral fluid in the confirmation reservoir 155. A confirmation plug 170 is provided within the confirmation reservoir 155 for removal of the confirmation sample, if confirmation is required. In the preferred embodiment, the confirmation plug 170 must be broken off in order to gain access to the confirmation sample. A security seal such as foil tape may also be placed over the cap 140 and housing 105 immediately after the cap is locked in place, to add another layer of security.

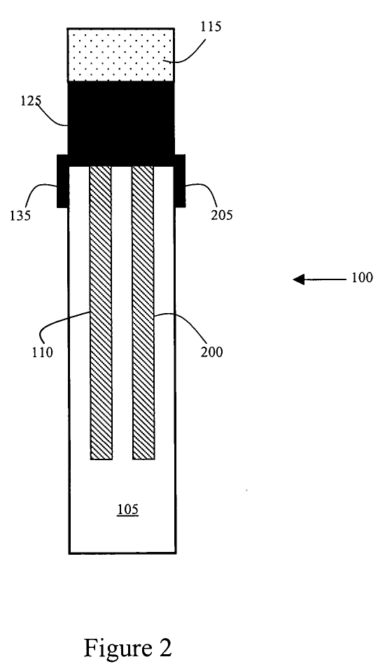

FIG. 2 shows a top view of the preferred embodiment 100. In this view the second test strip 200 is visible. The tops of both test strips 110 and 200, which includes the results section of the test strips, are visible through the top of the housing 105. So reading the results of each strip is as simple as looking at the top of the device. In the preferred embodiment 100, the test strips 110 and 200 are manufactured to detect the test subject's use of cocaine, amphetamines, THC, opiates, or PCP. In alternative embodiments, other drugs of abuse can be tested for and at least one section of a test strip detects contaminants in the sample that are intended to interfere with the testing process. In other embodiments, the test strips can be used to indicate whether or not a woman is pregnant and also be used to indicate an illness or other condition. A results guide may be provided on the housing 105 of the present device, on a label for example, to aid an administrator in reading the results of the test. The protective shield 125 is preferably made of a flexible material so that the shield does not cause any damage to the test subject's teeth when the device is inserted in the mouth of the test subject. Both female portions 135 and 205 of the locking mechanism for securing the cap 140 to the housing 105 are also shown in FIG. 2.

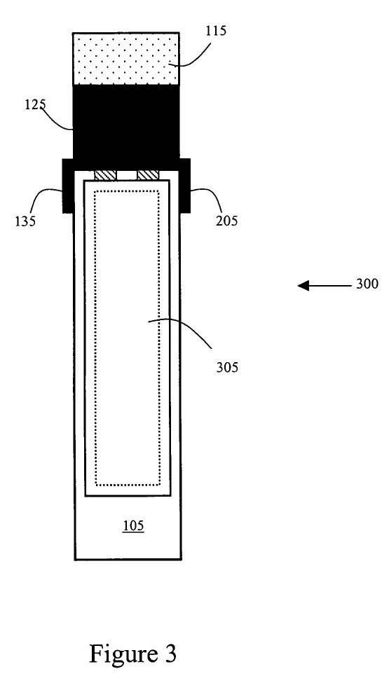

FIG. 3 is the top view of an alternate embodiment 300, which includes a privacy label 305 to cover the test strips. The privacy label can be an adhesive backed label, which is applied to the top of the housing 105. The label may also contain a viewing window that allows viewing of the portions of the test strips that are in contact with the swab 115 to verify adequate saturation. At an appropriate time, the label 305 or a portion of the label can be removed by an administrator to allow viewing of the test result section of the test strips.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A device that is adapted for partial insertion into a test subject's mouth, wherein the device efficiently collects oral fluid from the test subject and automatically begins a testing process on the collected oral fluid, the device comprising:
a handle that defines a substantial length of the device, the handle having a closed end and an open end, wherein at least one test strip is housed within an interior of the handle;
a collection swab that is connected to the open end of the handle, the collection swab being attached to the handle by a swab support; and,
a flow assisting material that connects the collection swab to the at least one test strip, wherein the flow assisting material aids in a movement of the collected oral fluid to the at least one test strip.

2. The device of claim 1, further comprising:
a shield, wherein the shield is attached to the open end of the handle and at least partially extends over the collection swab, the shield being designed to prevent damage and tampering to the flow assisting material and the at least one test strip.

3. The device of claim 1, further comprising:
a cap that can be placed over the collection swab and into a locked position after collection of the oral fluid, wherein the cap completely covers the collection swab and locks onto the handle so that the cap cannot be removed without breaking a locking mechanism.

4. The device of claim 3, wherein the cap includes an espressor plate that at least partially compresses the collection swab when the cap is placed in the locked position, and a confirmation reservoir that receives a small amount of the oral fluid from the at least partially compressed collection swab when the cap is placed in the locked position.

5. The device of claim 4, wherein the confirmation reservoir includes a confirmation seal, including a confirmation plug, that must be broken in order to remove the small amount of oral fluid from the confirmation reservoir.

6. The device of claim 1, wherein the at least one test strip is able to indicate use of drugs of abuse, including cocaine, heroin and amphetamines, by the test subject.

7. The device of claim 1, wherein the handle is made of a clear material and the at least one test strip is visible through a top of the handle.

8. The device of claim 1, wherein the handle includes a privacy label that prevents viewing of the at least one test strip, wherein the privacy label may include information on the test subject and can be removed by test administrators to allow viewing of the at least one test strip.

9. The device of claim 1, wherein the collection swab is made of an absorbent material with an ability to saturate itself when exposed to oral fluids.

10. The device of claim 1, wherein the collection swab is adapted to remain in the test subject's mouth for 2-4 minutes in order for complete saturation of the swab to occur.

11. The device of claim 1, wherein the at least one test strip tests for something other than drugs of abuse, including pregnancy confirmation.
